(19) United States
(12) Patent Application Publication
(10) Pub. No.: US 2025/0163988 A1
(43) Pub. Date: May 22, 2025

(54) SHOCK SAG VALUE GENERATING ASSEMBLY

(71) Applicant: Fox Factory, Inc., Duluth, GA (US)

(72) Inventors: Craig Richey, Courtenay (CA); Thomas Pollock, Mills River, NC (US); Adam Marriott, St. Joseph, IL (US); Nathan Wright, Asheville, NC (US); Joshua Coaplen, Asheville, NC (US)

(73) Assignee: Fox Factory, Inc., Duluth, GA (US)

(21) Appl. No.: 18/814,379

(22) Filed: Aug. 23, 2024

Related U.S. Application Data
(60) Provisional application No. 63/534,506, filed on Aug. 24, 2023.

(51) Int. Cl. F16F 9/50; B62K 25/08; F16F 9/32

(52) U.S. Cl. CPC F16F 9/50; B62K 25/08; F16F 9/3292; F16F 2230/18

(57) ABSTRACT

A shock sag value generating assembly is disclosed. The shock includes an upper tube telescopically engaged with a lower tube, and the sag value generating assembly includes a first sag value generating component located relative to one of the upper tube and the lower tube and a second sag value generating component slidably coupled about an outer diameter of one of the upper tube and the lower tube.

### CROSS-REFERENCE TO RELATED APPLICATIONS (PROVISIONAL)

This application claims priority to and benefit of co-pending U.S. Provisional Patent Application No. 63/534,506 filed on Aug. 24, 2023, entitled “Fork Lower Leg Sag Markings” by Craig Richey, and assigned to the assignee of the present application, the disclosure of which is hereby incorporated by reference in its entirety.

### FIELD OF THE INVENTION

Embodiments of the invention generally relate to the field of vehicle suspension tuning.

### BACKGROUND OF THE INVENTION

Vehicle suspension systems typically include a spring component or components and a damping component or components that form a suspension to provide for a comfortable ride, enhance performance of a vehicle, and the like. For example, a firmer suspension is usually preferred on smooth terrain while a softer suspension is often the choice for an off-road or bumpier environment. However, suspension system set-up and tuning is a difficult art to master and even the best intended user implemented changes can often move suspension characteristics into ranges that are beyond the manufacturer recommended operating ranges.

Moreover, suspension tuning can be highly subjective and downright confusing. For example, it is sometimes the case that one set of suspension parameters (often referred to as a ‘tune’) may be optimal for one user or one vehicle but may not apply to another user, even when they are using the same vehicle.

Moreover, the initial sag of a bicycle suspension needs to be properly setup for each rider to ensure the suspension is operating within the appropriate range. Without the proper sag settings, the ride handling and performance can be deleteriously affected. However, setting the proper sag is not a one and done, they did it at the shop before the bike was purchased, process. Instead, the sag settings have different values based on rider weight, gear, riding style, bicycle components, bicycle type, etc. Presently, the procedure for setting the initial sag includes making calculations and using equations that can easily cause confusion at best and often times are simply ignored by novices and even experienced riders.

### BRIEF DESCRIPTION OF THE DRAWINGS

FIG. 1 is a side view of a bicycle with a shock sag value generating assembly, in accordance with an embodiment.

FIG. 2 is a perspective view of a front fork assembly having a shock sag value generating assembly incorporated therewith, in accordance with one embodiment.

FIG. 3 is a side view of the front fork assembly showing a number of components of the shock sag value generating assembly incorporated therewith, in accordance with one embodiment.

FIG. 4A is a side view of a portion of the front fork assembly including the shock sag value generating assembly in a pre-sag evaluation condition, in accordance with one embodiment.

FIG. 4B is a side view of a portion of the front fork assembly including the shock sag value generating assembly in a sag evaluation condition, in accordance with one embodiment.

FIG. 5A is a rear view of the relevant portions of the front fork and shock sag value generating assembly in an unloaded condition, in accordance with one embodiment.

FIG. 5B is a rear view of the relevant portions of the front fork and shock sag value generating assembly in a sag test loaded condition, in accordance with one embodiment.

FIG. 5C is a rear view of the relevant portions of the front fork and shock sag value generating assembly in a sag evaluation condition, in accordance with one embodiment.

FIG. 6 is a side view of an inverted front fork assembly having the shock sag value generating assembly incorporated therewith, in accordance with one embodiment.

FIG. 7 is a side view of a front fork assembly with a rear facing arch having the shock sag value generating assembly incorporated therewith, in accordance with one embodiment.

FIG. 8 is a side view of a portion of the bicycle of FIG. 1 including a closer view of the shock assembly, in accordance with one embodiment.

FIG. 9 is a perspective view of a rear shock assembly having a shock sag value generating assembly incorporated therewith, in accordance with one embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

In the following discussion, and for purposes of clarity, a bicycle is utilized as the example vehicle. However, in another embodiment, the vehicle could be one any one of a variety of vehicles such as, but not limited to, a bicycle, a motorized bicycle, a motorcycle, or the like. In general, a motorized bicycle can include a bicycle with a combustion motor, an electric bicycle (e-bike), a hybrid electric and combustion bicycle, a hybrid motor and pedal powered bicycle, and the like.

In the following discussion, the term initial sag settings or “sag” refers to a pre-defined vehicle ride height and suspension geometry based on the initial compression of one or more shock assemblies of the suspension system for a given vehicle when it is within its normal load envelope configuration (e.g., in the case of a bicycle or motorcycle, the weight of the rider and their riding gear.).

For example, with respect to a bicycle, sag refers to the amount a bicycle suspension is compressed when a rider is on the bike but not moving.

Once the sag is established, it will be the designated ride height of the vehicle, until and unless the sag is changed.

The initial sag for a vehicle is usually established by the manufacturer. The vehicle sag can then be modified and/or adjusted by an owner, a mechanic, or the like. Often, the higher the ratio of rider weight to vehicle weight, the more important it is to adjust the initial sag for the rider. Thus, on a bicycle where the rider's weight is more (and usually substantially more) than the weight of the bike, the initial sag should always be adjusted for the rider to ensure proper performance. With respect to front fork assemblies, the sag range is normally set to 15-20% of total fork travel where 15% would be a firmer suspension setting than 20%. However, the sag range (and/or a specific sag determination) for a given front fork assembly, a given rider, and/or a given use case, can be a percentage that is more or less than 15-20%.

Additional information regarding sag and sag setup can be found in U.S. Pat. No. 8,838,335 the content of which is incorporated by reference herein, in its entirety.

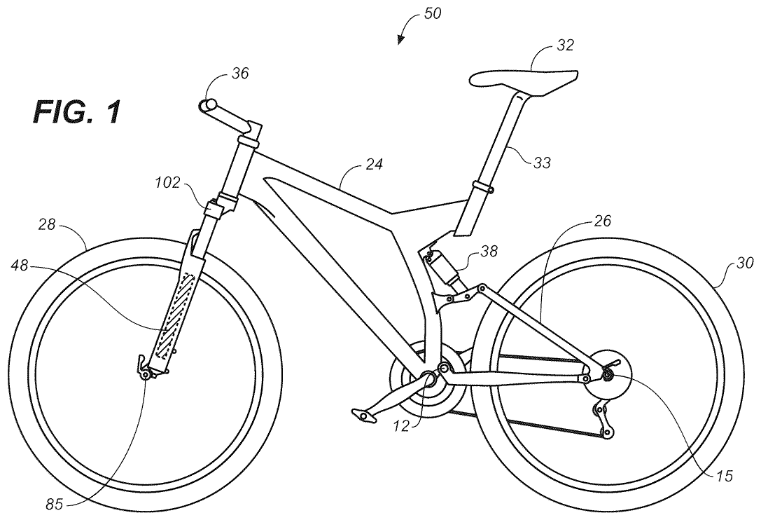

Referring now to FIG. 1, a schematic side view of a bicycle 50 having a shock sag value generating assembly incorporated therewith is shown in accordance with an embodiment. In one embodiment, bicycle 50 has a frame 24 with a suspension system comprising a swing arm 26 that, in use, is able to move relative to the rest of frame 24; this movement is permitted by, inter alia, shock assembly 38. The front fork assembly 102 also provide a suspension function via a damper 48 in at least one fork leg; as such the bicycle 50 is a full suspension bicycle (such as an ATB or mountain bike).

However, the embodiments described herein are not limited to use on full suspension bicycles. In particular, the term “suspension system” is intended to include vehicles having front suspension only, rear suspension only, seat suspension only, a combination of two or more different suspension types, and the like.

In one embodiment, swing arm 26 is pivotally attached to the frame 24 at pivot point 12. Although pivot point 12 is shown in a specific location, it should be appreciated that pivot point 12 can be found at a different location. In a hard tail bicycle embodiment, there would be no pivot point 12. In one embodiment of a hardtail bicycle, frame 24 and swing arm 26 would be formed as a fixed frame.

Bicycle 50 includes a front wheel 28 which is coupled with the front fork assembly 102 via front axle 85. In one embodiment, a portion of front fork assembly 102 (e.g., a steerer tube) passes through the frame 24 and couples with handlebars 36. In so doing, the front fork assembly and handlebars are rotationally coupled with the frame 24 thereby allowing the rider to steer the bicycle 50.

Bicycle 50 includes a rear wheel 30 which is coupled to the swing arm 26 at rear axle 15, and a rear damping assembly (e.g., shock assembly 38) is positioned between the swing arm 26 and the frame 24 to provide resistance to the pivoting motion of the swing arm 26 about pivot point 12. In one embodiment, a saddle 32 is connected to the frame 24 via a seatpost 33. In one embodiment, seatpost 33 is a dropper seatpost. In one embodiment, damper 48, shock assembly 38, seatpost 33, handlebars 36, and/or the like include one or more active damping components.

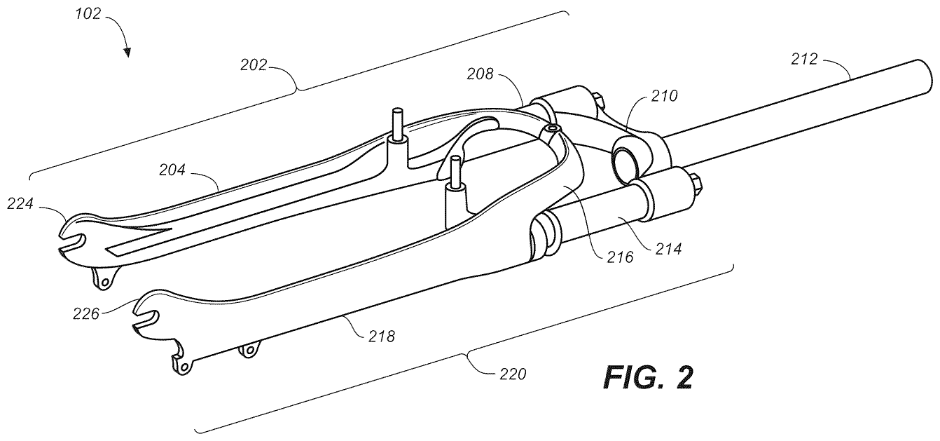

Referring now to FIG. 2, a perspective view of the front fork assembly 102, as being detached from the bicycle 50 of FIG. 1, is shown in accordance with an embodiment. In one embodiment, the front fork assembly 102 is a FOX 36 front fork assembly. In one embodiment, the front fork assembly 102 is another style of front fork assembly 102.

The front fork assembly 102 include right and left legs, 202 and 220, respectively, as referenced by a person in a riding position on the bicycle 50. The right leg 202 includes a right upper tube 208 telescopingly received in a right lower tube 204. Similarly, the left leg 220 includes a left upper tube 214 telescopingly received in a left lower tube 218. In one embodiment, the upper tube(s) are known as fork stanchion(s) and as shown and described, are coupled with the crown 210 and slide down inside of the fork lower tube (or lower leg) during movement through the fork travel.

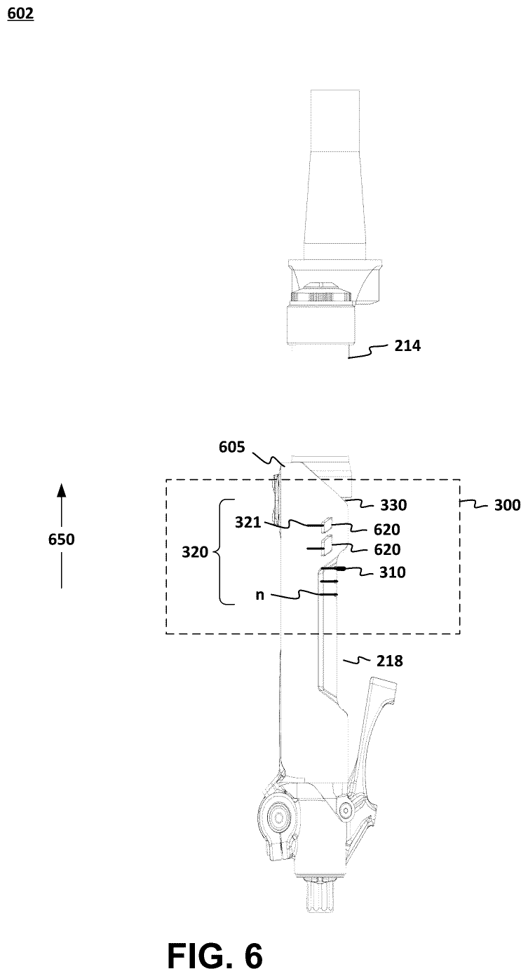

In one embodiment, the telescoping of the legs is inverted (as shown in FIG. 6). That is, the right lower tube 204 of right leg 202 is telescopingly received in the right upper tube 208. Similarly, the left lower tube 218 of left leg 220 is telescopingly received in the left upper tube 214.

A crown 210 connects the right upper tube 208 to the left upper tube 214 thereby connecting the right leg 202 to the left leg 220 of the front fork assembly 102. In addition, the crown 210 supports a steerer tube 212, which passes through, and is rotatably supported by, the frame 24 of the bicycle 50. The steerer tube 212 provides a means for connection of the handlebars 36 to the front fork assembly 102.

Each of the right lower tube 204 and the left lower tube 218 includes dropouts 224 and 226, respectively, for connecting the front wheel 104 to the front fork assembly 102 via a front axle 85. An arch 216 connects the right lower tube 204 and the left lower tube 218 to provide strength and minimize twisting thereof.

In one embodiment, the arch 216 is coupled with right lower tube 204 and left lower tube 218. In the following discussion, for purposes of clarity, front fork assembly 102 is shown in a standard telescoping configuration. However, it should be appreciated that in one embodiment, the features of the shock sag value generating assembly are similarly implemented on an inverted front fork assembly 102.

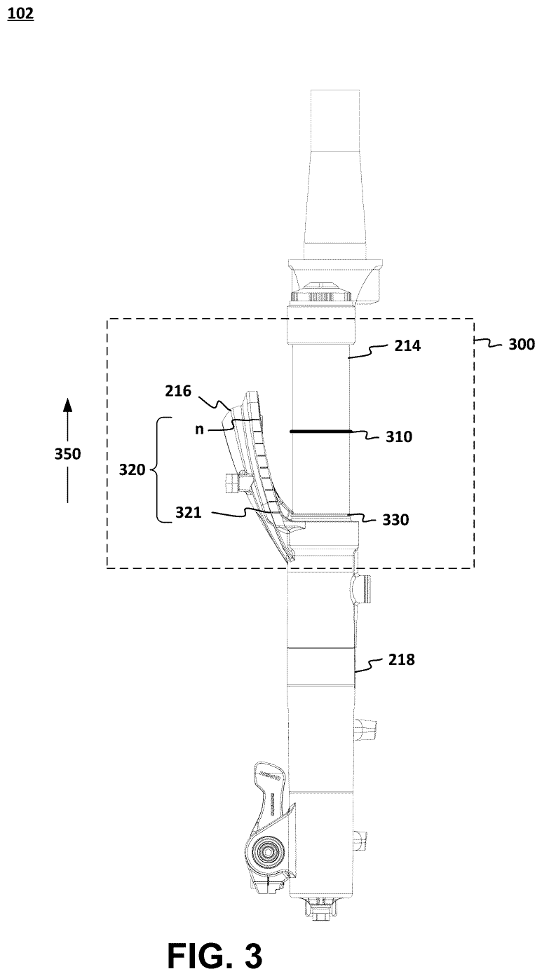

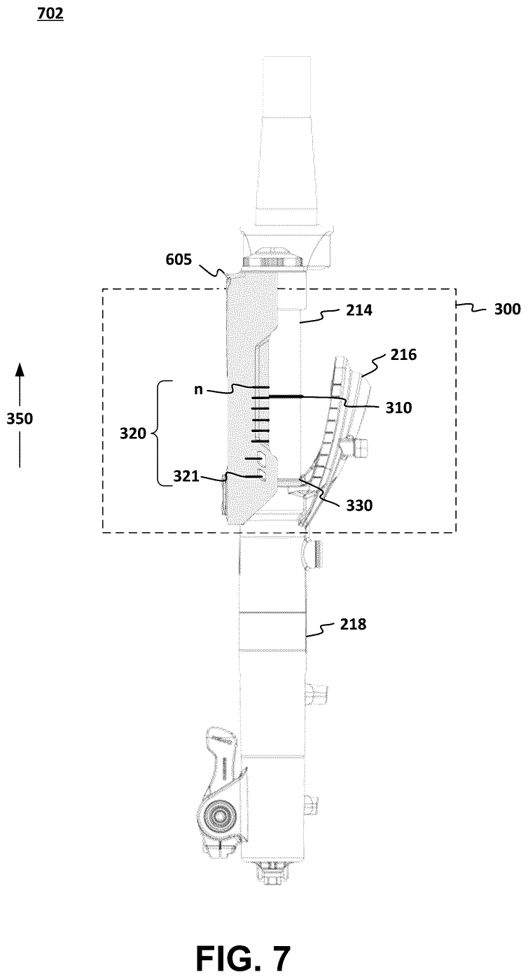

In one embodiment, as shown in FIG. 3, arch 216 is located on front fork assembly 102 in front of the steering axis (as seen by a rider), e.g., on the front facing side of front fork assembly 102 with respect to bicycle 50. In another embodiment, as shown in FIG. 7, arch 216 is located on front fork assembly 102 behind the steering axis (as seen by a rider), e.g., on the rear facing side of front fork assembly 102 with respect to bicycle 50.

### Fork Arch

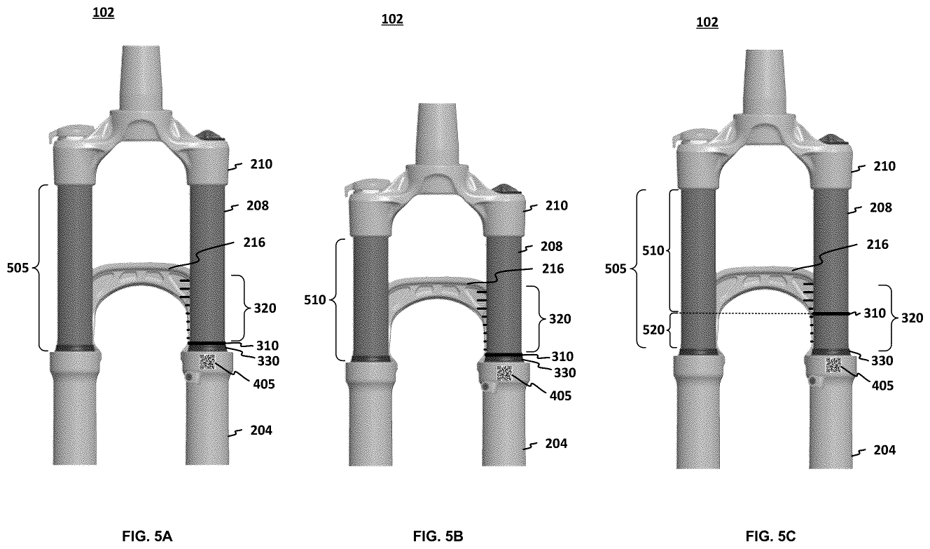

Referring now to FIG. 3, a side view of the front fork assembly 102 showing a number of components of the shock sag value generating assembly 300 incorporated therewith is shown in accordance with one embodiment. FIG. 5A is a rear view of the relevant portions of the front fork assembly 102 and shock sag value generating assembly 300 in an unloaded condition, shown in accordance with one embodiment.

In general, the front fork assembly 102 of FIG. 3 and FIG. 5A are similar except for the viewing location/orientation of the shock sag value generating assembly 300 components. For example, in FIG. 3, the first sag value generating component 320 is located such that is visible from a side on view of the front fork assembly 102 (as mounted on bicycle 50). In contrast, in FIG. 5A, first sag value generating component 320 is located such that is visible from a frame 24 forward view of the front fork assembly 102 (as mounted on bicycle 50 of FIG. 1).

In one embodiment, there are a plurality of first sag value generating components located on arch 216 such that it is visible from a plurality of directions. For example, a first sag value generating component 320 would be located on a right side, and/or left side, and/or front side, and/or rear side of arch 216. Thus, the first sag value generating component 320 would be visually attainable from a plurality of directions.

By combining the embodiments of FIGS. 3 and 5A, the first sag value generating component 320 would be visible while looking at the side of bicycle 50 and also while looking from frame 24 toward the front fork assembly 102, etc. In other words, the arch would include the first sag value generating component 320 on the side of the arch 216 as shown in FIG. 3, and the first sag value generating component 320 on the rear of arch 216 as shown in FIG. 5A.

Referring now to both FIGS. 3 and 5A, in one embodiment, shock sag value generating assembly 300 includes a first sag value generating component 320 coupled with arch 216, and a second sag value generating component 310 coupled with an upper tube (e.g., right upper tube 208 or left upper tube 214).

In one embodiment, arch 216 extends upward (in direction 350) from the right lower tube 204 and/or the left lower tube 218 a distance of at least twenty percent of a total stroke length 505 of the suspension.

In one embodiment, first sag value generating component 320 includes a number of marks 321-n visibly located on arch 216. In one embodiment, the marks 321-n are lines. In another embodiment, the marks 321-n are other geometric shapes, size, colors, etc. In one embodiment, marks 321-n are built into an arch mold, such that the first sag value generating component 320 is integrated with the arch 216 during the manufacture of arch 216. In one embodiment, the marks 321-n are laser etched, milled, and the like into an existing arch 216.

In one embodiment, the first sag value generating component 320 is not required to be located on the upper tube for a number of reasons. For example, a given fork model typically comes in multiple suspension travel configurations, which means multiple measurements may need to be printed on the upper tube to accommodate the different travel configurations. Printing on the upper tube is also an additional process and cost during fork production. Visually the measurement markings on the upper tube can be unappealing, subject to wear, and even wearing away to further exaggerates a worn appearance.

In one embodiment, the first sag value generating component 320 is not an additional part clipped onto the fork such that it cannot fall off, be knocked off, have its position jostled resulting in incorrect readings, etc.

In one embodiment, marks 321-n identify actual units of measurement (e.g., millimeters, centimeters, inches, etc.). For example, if the maximum suggested sag for the fork is 20% and the total stroke length 505 is 170 mm, the marks 321-n would be spaced in 5 mm intervals with the first mark 321 starting at 0 mm (e.g., even with the dust wiper 330) and the last hash line n located 50 mm from the dust wiper 330 (e.g., 30% of the total stroke length 505). In another embodiment, the marks 321-n would be spaced in 5 mm intervals with the first mark 321 located at an offset distance above the dust wiper 330. For example, if the minimum sag for the fork is 10% and the total stroke length 505 is 170 mm, the first hash line might be located 10 or 15 mm above the dust wiper 330. Although a number of values are disclosed, they are representative of one or more embodiments. In another embodiment, the spacing, range, and/or total number of marks 321-n is different.

In another embodiment, marks 321-n indicate percentage of compression for the front fork assembly 102. For example, if the front fork assembly has a total stroke length 505 of 200 mm, the marks 321-n would be placed in distances measured as percentage of stroke. For example, in one embodiment, there would be a hash mark every 5 percent for the first 30% of the stroke length.

In one embodiment, regardless of the scale used, one or more marks 321-n located within the normal sag range of the first sag value generating component 320 would be different (e.g., in color, shape, size, etc.). Thus, when performing a sag check, the user would be able to quickly determine if they are within an appropriate sag range.

For example, if the optimal “everyday” sag was 15% for a given front fork assembly 102, the hash markings around 15% of the stroke measured 520 length (described in further detail herein) would be green (or other color/shape/size) to indicate good, while the hash markings at 10% and 20% would be yellow (or other color/shape/size) to indicate a sag adjustment warning. Finally, the hash markings outside of 10-20% might be red to indicate a sag adjustment is needed. As such, a novice or intermediate user would be able to use the shock sag value generating assembly 300 to perform a quick ballpark sag tuning and/or maintaining without feeling overwhelmed. Similarly, a user of any level would be able to hop on and off their bike and quickly confirm/verify the sag setting.

With reference still to FIGS. 3 and 5A, second sag value generating component 310 is slidably coupled about an outer diameter (OD) of an upper tube (e.g., right upper tube 208 or left upper tube 214). In one embodiment, the shock sag value generating assembly 300 will include two second sag value generating components, e.g., one second sag value generating component 310 coupled with right upper tube 208 and another second sag value generating component 310 coupled with left upper tube 214. However, for purposes of clarity in the following discussion, only a single second sag value generating component 310 is shown and discussed.

In one embodiment, second sag value generating component 310 is a sliding ring, O-ring, loop, gasket, or the like. Second sag value generating component 310 is slidably coupled about the OD of upper tube (e.g., right upper tube 208 or left upper tube 214) such that it will retain its position about the upper tube when unmolested, but is able to be moved downward (e.g., opposite direction 350) by a user until it is against the dust wiper 330 and also moved upward (e.g., in direction 350) by the dust wiper 330 (or other component) as the upper tube moves into the lower tube during a compression of the front fork assembly 102.

In one embodiment, the second sag value generating component 310 will be moved down until it can move no further (e.g., in contact with the dust wiper 330) at some point of the loading phase of the sag measurement operation.

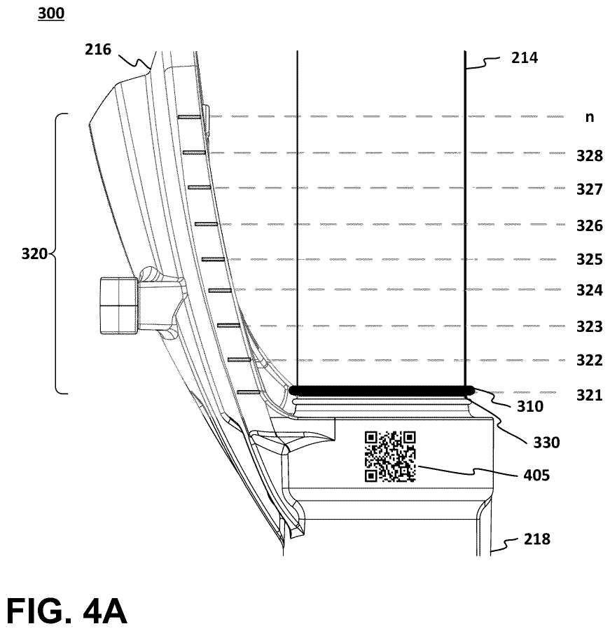

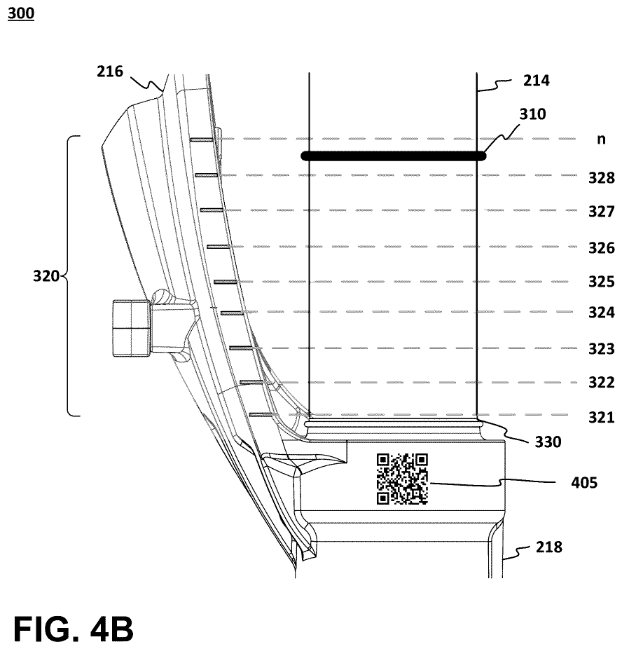

With reference now to FIG. 4A, a side view of a portion of the front fork assembly 102 including the shock sag value generating assembly 300 in a loaded condition (e.g., with rider and gear on the vehicle) is shown in accordance with one embodiment. FIG. 5B is a rear view of the relevant portions of the front fork assembly 102 and shock sag value generating assembly 300 in a loaded condition in accordance with one embodiment. Other than the loading of the front fork assembly 102, the components and operation of FIG. 4A and FIG. 5B are similar to the discussion of the components of FIGS. 3 and 5A, and as such, are not repeated for purposes of clarity but are incorporated herein by reference.

Similar to the discussion of FIGS. 3 and 5A above, the difference between FIG. 4A and FIG. 5B is the viewing location/orientation of shock sag value generating assembly 300. Thus, similar to as described above, in one embodiment, by combining the embodiments of FIGS. 4 and 5B, the first sag value generating component 320 would be visible while looking at the side of bicycle 50 and also while looking from frame 24 toward the front fork assembly 102, etc. In other words, the arch would include the first sag value generating component 320 on the side of the arch 216 as shown in FIG. 4, and the first sag value generating component 320 on the rear of arch 216 as shown in FIG. 5B.

As shown in FIGS. 4A and 5B, in one embodiment, the first sag value generating component 320 is located against the dust wiper 330 (or other component at the upper end of the lower tube) during the loading phase of the sag evaluation. That is, the user (and their associated riding gear) are sitting on the vehicle, may or may not have bounced the suspension, and the front fork assembly 102 is settled in its somewhat compressed (due to the added weight of the user and gear).

In one embodiment, once the front fork assembly 102 of the user loaded vehicle is in its settled partially compressed state the upper tube will have a loaded visible length 510 and the first sag value generating component 320 will be located such that it is just above (e.g., against) the dust wiper 330 (or other component at the upper end of the lower tube) on the upper tube.

In one embodiment, after the first sag value generating component 320 is properly located and/or the loaded visible length 510 is determined, the user (and riding gear) will be removed. At that point, the upper tube of the front fork assembly 102 will rebound into its extended state (the total stroke length 505).

Referring now to FIG. 4B, a side view of a portion of the front fork assembly 102 including the shock sag value generating assembly 300 in a sag evaluation condition is shown in accordance with one embodiment. FIG. 5C is a rear view of the relevant portions of the front fork assembly 102 and shock sag value generating assembly 300 in a sag evaluation condition, in accordance with one embodiment. The components and operation of FIG. 4B and FIG. 5C are similar to the discussion of the components of FIGS. 3 and 5A, and as such, are not repeated for purposes of clarity but are incorporated herein by reference.

In one embodiment, as the inner tube moves upward (in direction 350) from its loaded visible length 510 to total stroke length 505, the second sag value generating component 310 will remain in a fixed location on the inner tube. As such, when the front fork assembly 102 is back to its total stroke length 505, the second sag value generating component 310 will be located between the loaded visible length 510 and the stroke measured 520 length.

### Inverted Fork Assembly

FIG. 6 is a side view of an inverted front fork assembly 602 having the shock sag value generating assembly 300 incorporated therewith, in accordance with one embodiment. In general, inverted front fork assembly 602 is similar in functionality and operation to front fork assembly 102 discussed herein. However, the telescoping of the legs is inverted. That is, the right lower tube 204 of right leg 202 is telescopingly received in the right upper tube 208. Similarly, the left lower tube 218 of left leg 220 is telescopingly received in the left upper tube 214.

Often, when the fork assembly is inverted, a guard 605 is mounted on inverted front fork assembly 602 to protect the lower tube(s) from impacts, rocks, debris, etc. This is normally important since the lower tube(s) of inverted front fork assembly 602 are telescopically moving into and out of the upper tube(s). Thus, impacts on the lower tube(s) could cause fluid leaks, dents, burs, etc. that could damage the seals or even stop the lower tube(s) from properly telescoping into and/or out of the upper tube(s).

In one embodiment, the operation of shock sag value generating assembly 300 is similar to the operation described herein.

However, in contrast to front fork assembly 102, the second sag value generating component 310 will be slidably coupled about an outer diameter (OD) of the lower tube (e.g., right lower tube 204 and/or left lower tube 218) inverted front fork assembly 602. In one embodiment, the shock sag value generating assembly 300 will include two second sag value generating components, e.g., one second sag value generating component 310 coupled with right lower tube 204 and another second sag value generating component 310 coupled with left lower tube 218. However, for purposes of clarity in the following discussion, only a single second sag value generating component 310 is shown and discussed.

Similarly, in contrast to front fork assembly 102, with respect to inverted front fork assembly 602, instead of being located at the fork arch the first sag value generating component 320 will be formed on the guard 605. In one embodiment, guard 605 includes one or more holes (or window(s) 620) therein. The window(s) 620 allow the visual identification of the second sag value generating component 310 when it would otherwise be visually blocked by the guard 605.

In one embodiment, the first sag value generating component 320 is located such that is visible from a side on view of inverted front fork assembly 602 (as mounted on bicycle 50). In another embodiment, first sag value generating component 320 is located such that is visible from a frame 24 forward view of inverted front fork assembly 602 (as mounted on bicycle 50 of FIG. 1).

In one embodiment, there are a plurality of first sag value generating components located on guard 605 such that it is visible from a plurality of directions. For example, a first sag value generating component 320 would be located on a right side, and/or left side, and/or front side, and/or rear side of guard 605. Thus, the first sag value generating component 320 would be visually attainable from a plurality of directions. Similarly, the window(s) 620 could be located through guard 605 such that they provide the capability to visually identify second sag value generating component 310 when looking at guard 605 from the right side, and/or left side, and/or front side, and/or rear side.

In one embodiment, first sag value generating component 320 includes a number of marks 320 visibly located on guard 605. In one embodiment, the marks 320 are lines. In another embodiment, the marks 320 are other geometric shapes, size, colors, etc. In one embodiment, marks 320 are built into a guard mold, such that the first sag value generating component 320 is integrated with the guard 605 during the manufacture of guard 605. In one embodiment, the marks 320 are laser etched, milled, attached, or the like into an existing guard 605. Additional mark 320 characteristics and/or features are described herein, and for purpose of clarity, those discussion are not repeated but are incorporated by reference in their entirety.

In one embodiment, at least one capturable code 405 (such as shown and described with respect to FIGS. 4A-5C) is coupled with inverted front fork assembly 602. In one embodiment, a plurality of capturable codes are located about inverted front fork assembly 602. The type, location, utilization, data, etc. of capturable code 405 is similar to the discussion of capturable code 405 herein and is not repeated for purposes of clarity. Instead, the capturable code 405 discussions are incorporated by reference in their entirety.

When the suspension is compressed, for example with the rider and gear to check the sag, the lower tube (e.g., left lower tube 218) moves in direction 650 into the upper tube (e.g., left upper tube 214). At that point, only the loaded visible length of lower tube will be visible. The second sag value generating component 310 is then moved along the lower tube until it is contact with dust wiper 330 (or other component coupled with the upper tube). When the rider gets off the vehicle, inverted front fork assembly 602 will rebound to its total stroke length and the second sag value generating component 310 will remain in a fixed location on the lower tube. As such, when inverted front fork assembly 602 is back to its total stroke length, the second sag value generating component 310 will indicate the stroke measured length. Using the different methodologies discussed herein, the second sag value generating component 310 will be used in conjunction with the first sag value generating component 320 to generate a sag value.

Front Fork Assembly with a Rear Facing Arch

FIG. 7 is a side view of a front fork assembly 702 with a rear facing arch 216 having the shock sag value generating assembly incorporated therewith, in accordance with one embodiment. In one embodiment, since the arch 216 is rear facing, the upper tube(s) will not be as protected as when the arch 216 is in front. Thus, it is valuable to use the guard 605 (as discussed in FIG. 6) to protect the upper tube(s) from dirt and damage. In one embodiment, the guard 605 is used when the arch 216 is front facing to provide an added level of protection. In other words, the guard 605 would be installed on front fork assembly 102 (of FIG. 3 for example).

Other than the addition of guard 605 (and the optional front or rear facing arch 216), the components and operation of the front fork assembly 702 are similar to the discussion of the components of FIG. 3 and the guard of FIG. 6, and as such, are not repeated for purposes of clarity but are incorporated herein by reference.

In one embodiment, at least one capturable code 405 (such as shown and described with respect to FIGS. 4A-5C) is coupled with front fork assembly 702 and/or guard 605. In one embodiment, a plurality of capturable codes are coupled with front fork assembly 702 and/or guard 605. The type, location, utilization, data, etc. of capturable code 405 is similar to the discussion of capturable code 405 herein and is not repeated for purposes of clarity. Instead, the capturable code 405 discussions are incorporated by reference in their entirety.

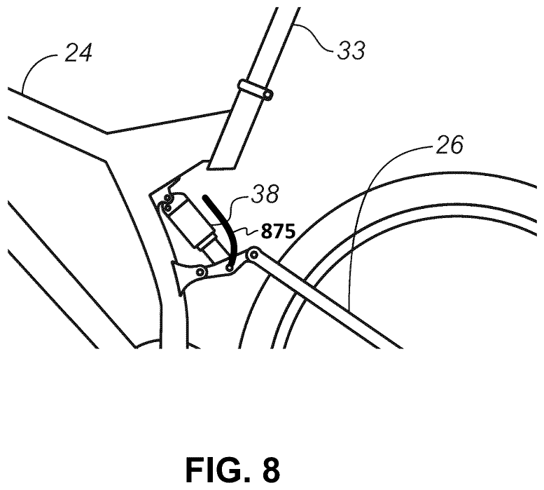

With reference now to FIG. 8 is a side view of a portion of bicycle 50 of FIG. 1 including a closer view of the shock assembly 38. In one embodiment, shock assembly 38 is protected by a guard 875. Although the guard 875 is shown in one embodiment with the given shape, it should be appreciated that guard 875 could be part of (or used in conjunction with) a larger deflective component such as a mudguard, fender, or the like.

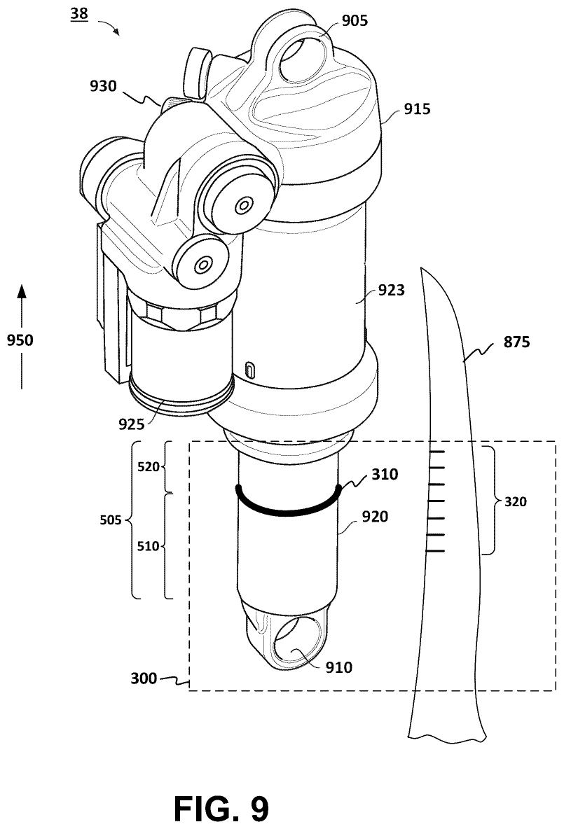

FIG. 9 shows a shock assembly 38 having a shock sag value generating assembly 300 incorporated therewith in accordance with one embodiment. In one embodiment, shock assembly 38 is a FOX™ Float shock assembly. In another embodiment, the shock assembly 38 is another type/model/brand of shock assembly.

FIG. 9 is a perspective view of shock assembly 38 having a shock sag value generating assembly 300 incorporated therewith, in accordance with one embodiment. In one embodiment, shock assembly 38 is a FOX™ Float shock assembly. In another embodiment, the shock assembly 38 is another type/model/brand of shock assembly.

Shock assembly 38 is a stand-alone fluid damper assembly, a coil sprung adjustable shock assembly, an air sprung fluid damper assembly, or the like. In its basic form, shock assembly 38 controls the speed of movement of a piston shaft by metering incompressible fluid from one side of the main piston to the other. In one embodiment, such as during a compression stroke, shock assembly 38 will also meter incompressible fluid from the main chamber to the reservoir 925, to account for the addition of the piston shaft volume as the piston shaft (coupled with the main piston) moves into the compression side of the main chamber and reduces the overall volume of the compression side of the main chamber. In one embodiment, such as during a rebound stroke, shock assembly 38 will also meter incompressible fluid from the reservoir 925 back to the main chamber to account for the overall volume change of the main chamber as the piston shaft (coupled with the main piston) moves out of the compression side of the main chamber.

In one embodiment, shock assembly 38 will include a mechanical spring (e.g., a helically wound spring that surrounds or is mounted in parallel with the body of the adjustable shock assembly). In one embodiment, shock assembly 38 will include an air spring. In one embodiment, shock assembly 38 will include both a mechanical spring and an air spring.

Although shock assembly 38 is described in conjunction with the rear of the vehicle, this is done for purposes of clarity. It should be appreciated that in some embodiments, some, most, or all, of the discussion of shock assembly 38 could be applied to a shock assembly within a seatpost 33, an exoskeleton, a seat frame of a vehicle, an adjustable shock assembly in a prosthetic appliance, or any other devices, vehicles, and the like, where a shock assembly may be utilized.

In one embodiment, shock assembly 38 includes a top cap portion 915, shaft end eyelet 905, lower eyelet 910, damper body 920, air sleeve 923, and reservoir 925. In one embodiment reservoir 125 is an external or piggyback type of reservoir. In another embodiment, reservoir 925 may be an internal reservoir. In one embodiment, shock assembly 38 may not include an external reservoir.

In one embodiment, shock assembly 38 includes a pneumatic valve 930 (e.g., a Shrader valve, Presta valve, Dunlop valve, or the like). The pneumatic valve 930 is used to adjust the air pressure and thus the sag of shock assembly 38.

Referring now to FIGS. 8 and 9, in one embodiment, shock sag value generating assembly 300 includes a first sag value generating component 320 coupled with guard 875, and a second sag value generating component 310 coupled with a lower tube (e.g., damper body 920).

In one embodiment, guard 875 is coupled with frame 24, swing arm 26, in a fixed location and extends (in direction 950) at least to the air sleeve 923 of shock assembly 38.

In one embodiment, guard 875 is coupled with shock assembly 38 (e.g., with top cap portion 915, shaft end eyelet 905, lower eyelet 910, air sleeve 923, reservoir 925, or the like) in a fixed location and extends along some or all of the length of air sleeve 923.

In one embodiment, first sag value generating component 320 includes a number of marks 320 visibly located on guard 875. In one embodiment, the marks 320 are lines. In another embodiment, the marks 320 are other geometric shapes, size, colors, etc. In one embodiment, marks 320 are built into a guard mold, such that the first sag value generating component 320 is integrated with the guard 875 during the manufacture of guard 875. In one embodiment, the marks 320 are laser etched, milled, and the like into an existing guard 875. Additional mark 320 characteristics and/or features are described herein, and for purpose of clarity, those discussion are not repeated but are incorporated by reference in their entirety.

The total stroke length 505 is shown with respect to damper body 920. When the suspension is compressed, for example with the rider and gear to check the sag, the damper body 920 moves in direction 950 into the air sleeve 923. At that point, the loaded visible length 510 of damper body 920 will be visible. The second sag value generating component 310 is then moved along damper body 920 until it is contact with air sleeve 923. When the rider gets off the vehicle, damper body 920 will rebound to its total stroke length 505 and the second sag value generating component 310 will remain in a fixed location on damper body 920. As such, when shock assembly 38 is back to its total stroke length 505, the second sag value generating component 310 will be located between the loaded visible length 510 and the stroke measured 520 length.

Using the different methodologies discussed herein, the second sag value generating component 310 will be used in conjunction with the first sag value generating component 320 to generate a sag value.

In one embodiment, at least one capturable code 405 (such as shown and described with respect to FIGS. 4A-5C) is coupled with shock assembly 38, guard 875, and/or frame 24. In one embodiment, a plurality of capturable codes are coupled with shock assembly 38, guard 875, and/or frame 24. The type, location, utilization, data, etc. of capturable code 405 is similar to the discussion of capturable code 405 herein and is not repeated for purposes of clarity. Instead, the capturable code 405 discussions are incorporated by reference in their entirety.

### Sag Value Generation and Adjustment

Determining sag (and determining the sag adjustments) will use the formula: Sag %=(stroke measured 520/total stroke length 505)*100

From this formula, the actual stroke measured 520 and total stroke length 505 can be used to determine the instant sag %.

Similarly, the desired sag % can be used in conjunction with the total stroke length 505 to determine the desired stroke measured 520.

Thus, by using the shock sag value generating assembly 300 the user can set an initial sag, confirm the sag is correct, adjust an existing sag, etc.

For example, as discussed herein, if the sag has been previously set, a user can use the shock sag value generating assembly 300 to quickly verify the sag. They can sit on the bike with their riding gear and during the loading phase of the sag measurement operation, move the second sag value generating component 310 into contact with the dust wiper 330. The user (and riding gear) will be removed allowing the front fork assembly 102 to rebound into its extended state (total stroke length 505). As the inner tube moves upward (in direction 350) from its loaded visible length 510 to total stroke length 505, the second sag value generating component 310 will remain in a fixed location on the inner tube between the loaded visible length 510 and the stroke measured 520 length.

The location of second sag value generating component 310 is compared with respect to the marks of the first sag value generating component 320 to quickly determine whether or not the sag is still properly set.

If the user is setting the sag, the user would use the desired sag % in conjunction with the total stroke length 505 to determine the desired stroke measured 520. For example, the desired sag % is 15% and the total stroke length 505 is 200 mm, then the desired stroke measured 520 would be 30 mm.

The user would then load the bike and move the second sag value generating component 310 into contact with the dust wiper 330. The bike would be unloaded allowing the front fork assembly 102 to rebound into its extended state and the second sag value generating component 310 will remain in a fixed location between the loaded visible length 510 and the stroke measured 520 length.

The user would then compare the location of second sag value generating component 310 with respect to the marks of the first sag value generating component 320 to quickly determine whether the sag needed to be increased. For example, if the stroke measured 520 length was 40 mm, then the user would need to add pressure to reduce the stroke measured 520 length. Once the user added pressure, they would repeat the loading and unloading to determine the new stroke measured 520 length. When the new stoked measured 520 length is the same or within a tolerable range of the desired stroke measured 520 length of 30 mm, the process would be complete.

### Capturable Code

In one embodiment, the shock sag value generating assembly 300 of FIG. 4A optionally includes a capturable code 405.

Capturable code 405 includes computer readable information such as, but not limited to, a fork make, a fork model number, performance characteristics (such as a total stroke length 505, suggested sag percentage(s), etc.), measurement scale information, a link to download and/or open a suspension application, and the like.

In one embodiment, the capturable code 405 is a 1D code, a 2D code (such as, but not limited to, a barcode, UPC, matrix barcode, QR code, Micro QR code, IQR code, Secure QR code, Frame QR code, high capacity colored 2D (HCC2D) code, SPARQCode, just another barcode (JAB code), portable data file (PDF) 417, SnapTag, Aztec code, etc.), a 3D code, a sound code (e.g., a Touchatag, TikiTag, etc.), a picture code, or the like.

In one embodiment, capturable code 405 is coupled with front fork assembly 102. In one embodiment, capturable code 405 is coupled with at least one lower tube (e.g., right lower tube 204 and/or left lower tube 218). In one embodiment, capturable code 405 is coupled with arch 216. In one embodiment, capturable code 405 is coupled with crown 210.

In one embodiment, a plurality of capturable codes are located on front fork assembly 102. For example, a capturable code 405 would be located on a right side, and/or left side, and/or front side, and/or rear side of front fork assembly 102. Thus, the capturable code 405 would be visually attainable from a plurality of directions. For example, while looking at the side of bicycle 50, while looking from frame 24 toward the front fork assembly 102, etc.

In one embodiment, the capturable code 405 is located in the same visual frame as the first sag value generating component 320. For example, on the side of the front fork assembly 102 as shown in FIGS. 4A and 4B, on the rear of the front fork assembly 102 as shown in FIGS. 5A-5C, in the combination of locations shown in FIGS. 4A-5C, or the like.

### Image Capture Device

In one embodiment, an image capture device is used to obtain an image of the first sag value generating component 320, the second sag value generating component 310, and/or the (optional) capturable code 405. In general, the image capture device could be a handheld device such as a mobile phone, a smart phone, a tablet, a smart watch, a piece of smart jewelry, smart glasses, a sensor coupled with bicycle 50, or the like having image capturing capabilities. In one embodiment, the image capture device is capable of broadcasting and/or receiving via at least one wired and/or wireless transmission method, such as, but not limited to, WiFi, Cellular, Bluetooth, NFC, and the like. In one embodiment, the image capture device also includes one or more of a display, a processor, a memory, a GPS, and the like.

In one embodiment, the image capture device includes a processor configured to utilize the imagery obtained by the image capture device to automatically determine a sag value of the suspension. In one embodiment, the image capture device send the captured data to a processor (such as a controller on the bicycle, a mobile device, a computer, or the like) configured to utilize the imagery obtained by the image capture device to automatically determine the sag value of the suspension. In one embodiment, the sag value is a real-time sag value determination.

In one embodiment, the first sag value generating component 320 is located in a side visible location of arch such that an image capturing device (such as a mobile phone, camera, visual sensor, or the like) can be used to capture an image of the side of front fork assembly 102 and the image will include the first sag value generating component 320, the second sag value generating component 310, and (optionally) the capturable code 405.

In one embodiment, the first sag value generating component 320 and/or the capturable code 405 are located in a rear facing visible location of the front fork assembly 102 such that an image capturing device (such as a mobile phone, camera, visual sensor, or the like) can be coupled with frame 24 and used to capture an image of the back side of front fork assembly 102. where the image will include the first sag value generating component 320, the second sag value generating component 310, and (optionally) the capturable code 405.

Additional information regarding capturable codes, sensor and imaging devices, there incorporation with a vehicle, and the utilization thereof is found in U.S. Pat. No. 10,086,670 the content of which is incorporated by reference herein, in its entirety.

### Automatic Sag Determination

In one embodiment, the sag setting adjustment is automatically determined. For example, by utilizing the image capture device in conjunction with the first sag value generating component, the second sag value generating component, and/or the capturable code. In one embodiment, the image capture device will send the information to a processor such as a mobile device, controller, etc. The processor will use the information from the capturable code (e.g., shock model data, etc.) in conjunction with the readings of the first and second sag value generating component, to calculate the change from the existing sag setting to the appropriate sag setting. The processor will output the information to the user in a user readable format.

For example, with reference still to FIGS. 4A-5C, in one embodiment, the image capture device will capture an image of the front fork assembly 102 when there is no weight added to the vehicle (e.g., an unloaded vehicle). In one embodiment, the image will include at least two of the first sag value generating component, the second sag value generating component, the (optional) capturable code 405, and/or the unloaded visible length (or total stroke length 505) of the right upper tube 208 (and/or left upper tube 214).

In one embodiment, the processor determines the total stroke length 505 in millimeters, centimeters, and/or inches, by performing a digital measurement on the image that does not include the first sag value generating component 320.

In another embodiment, the processor determines the total stroke length 505 based on the scale provided by first sag value generating component 320. For example, if the scale has 10 evenly spaced marks 321-n, the processor would extrapolate the unloaded visible length of the right upper tube 208 (and/or left upper tube 214) to be a total length of 45 marks.

In one embodiment, when the capturable code is present, the processor will use the information from the capturable code (e.g., the shock model data, specific provided data such as the resting extended length of the upper tube, etc.) to identify the total stroke length 505 of the right upper tube 208 (and/or left upper tube 214).

The processor will also identify the appropriate “stroke used”. The appropriate “stroke used” could be obtained by using rider information (such as weight, skill level, activities, etc.) to check a performance chart for the identified fork model and/or within the data of the capturable code.

If the appropriate “stroke used” cannot be determined from the available information, the processor can use the desired sag percentage to determine the appropriate “stroke used”. For example, the sag percentage could be within the data of the capturable code 405, within the model data available to the processor, or provided by a user input. Once the total stroke length 505 and the desired sag percentage are identified. The processor will use those values to calculate the correct “stroke used” for the desired sag.

Once the correct “stroke used” is determined or identified, the user (including their riding gear) would sit on the bike and the image capture device will begin to capture imagery of the loaded front fork assembly 102 including the loaded visible length 510.

In one embodiment, the processor determines the total loaded visible length 510 in millimeters, centimeters, and/or inches, by performing a digital measurement on the loaded front fork assembly 102 imagery that does not include the first sag value generating component 320.

In one embodiment, the processor determines the actual stoke measured 520 by subtracting the digitally measured total loaded visible length 510 from the digitally measured total stroke length 505.

In one embodiment, the processor will calculate the correct “stroke used” based on the desired sag and the total stroke length 505 and provide the correct “stroke used” length to the user. The user will adjust the air pressure of the shock until the stroke measured 520 is the same or approximately the same as the provided “stroke used”.

In another embodiment, the processor will compare the correct “stroke used” with the stroke measured 520 and provide an adjustment course of action to the user.

In one embodiment, instead of providing a correct “stroke used” as output, the processor will subtract the correct “stroke used” from the total stroke length 505. This will result in the correct “loaded visible length” measurement.

The processor will provide the correct “loaded visible length” and the user will adjust the air pressure of the shock, while the bike is under the rider load, until the loaded visible length 510 is the same or approximately the same as the correct “loaded visible length”.

In another embodiment, the processor will compare the correct “loaded visible length” with the loaded visible length 510 and provide an adjustment course of action to the user who will adjust the air pressure of the shock, while the bike is under the rider load, until the loaded visible length 510 is the same or approximately the same as the correct “loaded visible length”.

In one embodiment, the course of action will be a specific solution for a technical user. For example, increase/decrease air pressure x percent, increase/decrease air pressure x bar/psi, etc.

In another embodiment, the solution is presented as a step-by-step type solution for a less technical user, e.g., presented as images, a video, or the like that will guide the user through the sag adjustment process.

In one embodiment, the solution is presented within the context of an application such as the connected component platform. In one embodiment, the application will make a request for data (or have previously obtained data), such as the present air pressure and provide a solution such as adjust air pressure to x, etc. Additional information regarding the connected component platform is found in U.S. Pat. No. 11,459,050 the content of which is incorporated by reference herein, in its entirety.

In one embodiment, the process is repeated after the sag has been adjusted to confirm the new sag setting is correct or determine any further sag adjustments.

### Automatic Sag Adjustment

In one embodiment, an initial sag setting is automatically determined and automatically adjusted. For example, by having a position valve within the damper 48 for a given length bleed off air pressure until a specific sag level is achieved.

In one embodiment, the pressure of damper 48 is increased to a maximum pressure of, for example, 300 psi or so. The actual max number is not important as long as the pressure is increased beyond any reasonable properly set sag pressure.

The image capture device will capture an image of the front fork assembly 102 when there is no weight added to the vehicle (e.g., an unloaded vehicle). In one embodiment, the image will include at least two of the first sag value generating component, the second sag value generating component, the (optional) capturable code 405, and/or the unloaded visible length (or total stroke length 505) of the right upper tube 208 (and/or left upper tube 214).

The processor determines the total stroke length 505 in millimeters, centimeters, and/or inches, by performing a digital measurement on the image. In another embodiment, the processor determines the total stroke length 505 based on the scale provided by first sag value generating component 320. For example, if the scale has 10 evenly spaced marks 321-n, the processor would extrapolate the unloaded visible length of the right upper tube 208 (and/or left upper tube 214) to be a total length of 45 marks.

When the capturable code is present, the processor will use the information from the capturable code (e.g., the shock model data, specific provided data such as the resting extended length of the upper tube, etc.) to identify the total stroke length 505 of the right upper tube 208 (and/or left upper tube 214).

The processor will also identify the appropriate “stroke used”. The appropriate “stroke used” could be obtained by using rider information (such as weight, skill level, activities, etc.) to check a performance chart for the identified fork model and/or within the data of the capturable code.

If the appropriate “stroke used” cannot be determined from the available information, the processor can use the desired sag percentage to determine the appropriate “stroke used”. For example, the sag percentage could be within the data of the capturable code 405, within the model data available to the processor, or provided by a user input. Once the total stroke length 505 and the desired sag percentage are identified. The processor will use those values to calculate the correct “stroke used” for the desired sag.

Once the correct “stroke used” is determined or identified, the user (including their riding gear) would sit on the bike and the image capture device will begin to capture imagery of the front fork assembly 102. The loaded state imagery will be used by the mobile device, controller, etc. in conjunction with an electronically controlled pressure relief valve (or electrically actuated valve, or other type of remote actuated valve) to bleed air pressure from damper 48 until the controller determines the shock is at its' proper sag. As the proper sag is achieved, the pressure relief valve is automatically closed.

For example, as previously discussed, in one embodiment, the pressure of damper 48 was set to a higher pressure that would be outside of the desired sag range. As the rider initially sits on the bike, the loaded visible length 510 would be greater than the correct “loaded visible length”. As such, the opening of the pressure relief valve would allow the loaded visible length 510 to decrease until it reached the correct “loaded visible length”. In one embodiment, the adjustment may be approximated, for example, a length within a small percentage of the correct “loaded visible length”.

In another example, when the processor is using the scale provided by first sag value generating component 320, and the total stroke length 505 was extrapolated to be 45 marks long the 18% sag value would result in a correct “loaded visible length” of 36.9 hashes (e.g., 8.1 hashes less than the unloaded length). Once again, since the pressure of damper 48 is initially set too high, when the rider sits on the bike, the loaded visible length 510 would be greater than 36.9 hashes. As such, the opening of the pressure relief valve would allow the loaded visible length 510 to decrease until it reached the 36.9 hash length. In one embodiment, the adjustment may be approximated, for example, a length of 37 hashes, etc.

In one embodiment, once the sag is adjusted, the rider might bounce, climb off and back on, or otherwise jostle the suspension before a post-sag adjustment measurement is performed. In the post-sag adjustment, the rider would again be on the bike and the shock sag value generating assembly 300 would be used to confirm the sag is proper.

In one embodiment, the shock sag value generating assembly 300 will intermittently perform the sag measurement to ensure the sag remains properly set. For example, the sag has been properly established a week ago, a month ago, a few months ago, at a different elevation/location, in a different temperature range, in a different season, etc. As such, the air pressure within the damper might have changed. By incorporating the shock sag value generating assembly 300 with the framework of the vehicle, the user would be able to sit on the bike anytime, anywhere to confirm the sag is proper, identify any sag adjustment needs, etc.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A suspension, comprising:
an upper tube telescopically engaged with a lower tube; and
a sag value generating assembly comprising:
a first sag value generating component located relative to one of said upper tube and said lower tube; and
a second sag value generating component slidably coupled about an outer diameter of said one of said upper tube and said lower tube.

2. The suspension of claim 1, further comprising:
a second upper tube telescopically engaged with a second lower tube; and
a fork arch coupling said lower tube with said second lower tube, wherein said fork arch extends above said lower tube and said second lower tube a distance of at least twenty percent of a total stroke length of said suspension.

3. The suspension of claim 2, wherein said first sag value generating component is built into an arch mold, such that said first sag value generating component is integrated with said arch during a manufacture of said arch.

4. The suspension of claim 2, wherein said first sag value generating component is added to said arch as a secondary process.

5. The suspension of claim 1, wherein said first sag value generating component is integrated with a cover of said shock assembly.

6. The suspension of claim 1, wherein said sag value generating assembly further comprises:
a capturable code coupled with at least one of said lower tube and said upper tube.

7. The suspension of claim 6, wherein said capturable code includes computer readable information selected from a group of suspension metrics consisting of: a make, a model number, a total stroke length, measurement scale information, and a link to download and/or open a suspension application.

8. The suspension of claim 6, wherein said capturable code is selected from a group consisting of: a 1D code, a 2D code, a 3D code, and/or a picture code.

9. The suspension of claim 6, further comprising:
an image capture device configured to obtain an image of said capturable code, said first sag value generating component, and said second sag value generating component; and
a processor configured to utilize said image obtained by said image capture device to automatically determine a real-time sag value of said suspension.

10. The suspension of claim 9, further comprising:
a tune application configured to receive said real-time sag value of said suspension from said processor and calculate a sag adjustment for said suspension.

11. A front fork assembly, comprising:
a first upper tube telescopically engaged with a first lower tube;
a second upper tube telescopically engaged with a second lower tube;
a fork arch coupling said first lower tube with said second lower tube; and
a sag value generating assembly comprising:
a first sag value generating component located relative to at least one of said first upper tube, said second upper tube, said first lower tube, or said second lower tube; and
a second sag value generating component coupled with at least one of said first upper tube, said second upper tube, said first lower tube, or said second lower tube.

12. The front fork assembly of claim 11, wherein said sag value generating assembly further comprises:
a capturable code coupled with at least one of said first upper tube, said second upper tube, said first lower tube, or said second lower tube.

13. The front fork assembly of claim 12, wherein said capturable code includes computer readable information selected from a group of front fork metrics consisting of: a make, a model number, a total stroke length, measurement scale information, and a link to download and/or open a front fork assembly application.

14. The front fork assembly of claim 12, wherein said capturable code is selected from a group consisting of: a 1D code, a 2D code, a 3D code, a picture code, and a combination thereof.

15. The front fork assembly of claim 12, further comprising:
an image capture device configured to obtain an image of said capturable code, said first sag value generating component, and said second sag value generating component; and
a processor configured to utilize said image obtained by said image capture device to automatically determine a real-time sag value of said front fork assembly.

16. The front fork assembly of claim 15, further comprising:
a tune application configured to receive said real-time sag value of said front fork assembly from said processor and calculate a sag adjustment for said front fork assembly.

17. The front fork assembly of claim 11, wherein said first sag value generating component is built into an arch mold, such that said first sag value generating component is integrated with said arch during a manufacture of said arch.

18. The front fork assembly of claim 11, wherein said first sag value generating component is added to said arch as a secondary process.

19. The front fork assembly of claim 11, wherein said second sag value generating component is slidably coupled about an outer diameter of said one of said first upper tube and said second upper tube.

20. A shock assembly, comprising:
an upper tube telescopically engaged with a lower tube; and
a sag value generating assembly comprising:
a first sag value generating component located relative to one of said upper tube and said lower tube; and
a second sag value generating component slidably coupled about an outer diameter of one of said upper tube and said lower tube.

21. The shock assembly of claim 20, wherein said first sag value generating component is built into an eyelet assembly.

22. The shock assembly of claim 20, wherein said first sag value generating component is integrated with a dust cover of said shock assembly.
